(19) United States
(12) Patent Application Publication
(10) Pub. No.: US 2011/0318259 A1
(43) Pub. Date: Dec. 29, 2011

(54) PROCESS FOR PREPARING CHLORINE

(75) Inventors: Martin Karches, Neustadt (DE); Kati Bachmann, Viernheim (DE); Martin Sesing, Waldsee (DE); Bernd Rumpf, Hockenheim (DE); Oliver Odenwald, Dielheim (DE); Lothar Seidemann, Bruxelles (BE)

(73) Assignee: BASF SE, Ludwigshafen (DE)

(21) Appl. No.: 13/255,111

(22) PCT Filed: Mar. 25, 2010
(86) PCT No.: PCT/EP2010/053864

§ 371 Date: Sep. 7, 2011

(30) Foreign Application Priority Data
Mar. 30, 2009 (EP) 09156626.5

(51) Int. Cl. C01B 7/04

(52) U.S. Cl. 423/502

(57) ABSTRACT

A process for preparing chlorine by oxidation of hydrogen chloride in the presence of a heterogeneous particulate catalyst by the Deacon process in a fluidized-bed reactor (1), in which the heat of reaction is removed by evaporative cooling by means of water which circulates in the tubes (2) of a shell-and-tube heat exchanger, with the water being fed from a steam drum (4) via a feed line (5) to the tubes (2) of the shell-and-tube heat exchanger at one end of these, being heated in the tubes (2) by uptake of the heat of reaction and partly vaporizing to give a water/steam mixture which at the other end of the tubes (2) of the shell-and-tube heat exchanger is recirculated via a return line (6) to the steam drum (4), wherein the maximum pressure for which the fluidized-bed reactor (1) has to be designed to allow for the event of rupture of a tube (2) of the shell-and-tube heat exchanger is minimized by a valve (7) which in the event of a pressure increase as a result of rupture of a tube (2) closes the feed line (5) and the return line (6) is installed in the feed line (5) and the return line (6) and thereby prevents water flowing from the steam drum (4) into the fluidized-bed reactor (1), is proposed.

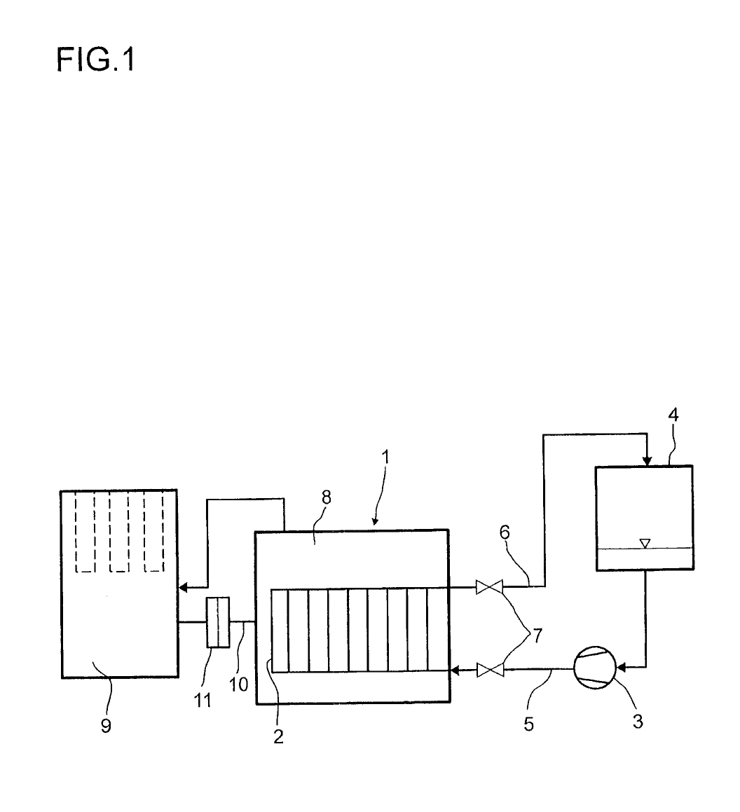

The invention relates to a process for preparing chlorine by oxidation of hydrogen chloride in the presence of a heterogenous particulate catalyst by the Deacon process in a fluidized-bed reactor.

A fluidized-bed reactor for preparing chlorine by oxidation of hydrogen chloride according to the Deacon process is described, for example, in DE-A 10 2004 014 677: the fluidized-bed reactor comprises a fluidized bed comprising the heterogeneous particulate catalyst which preferably comprises a metal component on an oxidic support, for example ruthenium or copper compounds on aluminum oxide, in particular γ-aluminum oxide or δ-aluminum oxide, zirconium oxide, titanium oxide or mixtures thereof. The reaction gases are introduced via a gas distributor into the fluidized bed, with at least one heat exchanger being located within the fluidized bed in order to control the temperature distribution.

The oxidation of hydrogen chloride to chlorine in the presence of a heterogenous particulate catalyst by the Deacon process in the fluidized-bed reactor is preferably carried out at temperatures in the range from 350 to 450° C. and pressures in the range from 1 to 10 bar gauge.

As is customary in process engineering, gauge pressure will in the present text be abbreviated as “bar gauge” and absolute pressure will be abbreviated as “bar a”.

A suitable means for removing heat of reaction from the fluidized bed is, in particular, boiling water since this can take up large quantities of heat at a constant temperature. The temperature of the water changes only when all of the water has been vaporized. The boiling temperature is dependent on the pressure. The higher the pressure of the boiling water, the higher the boiling temperature. A shell-and-tube heat exchanger is preferably used as heat exchanger.

For economic reasons, it is useful to operate the shell-and-tube heat exchanger for removal of the heat of reaction from the fluidized bed at a very high temperature and thus a very high pressure because this is advantageous for starting up the reactor and also provides steam at a higher pressure level and thus of higher quality.

The tubes of the shell-and-tube heat exchanger are corroded by the aggressive, chlorine-comprising reaction mixture and also abraded by the catalyst particles of the fluidized bed. This can lead to cracks and finally complete rupture of tubes. A further disadvantage of this process is that cracks through which water or steam can escape from the tube into the reactor cannot be detected since the heat exchange medium in the tube is water and the reaction mixture likewise comprises water. Malfunction as a result of damage to a tube can therefore only be detected when so much water or steam flows out into the reactor that a pressure increase in the reactor results.

Retention devices for the heterogeneous particulate catalyst have to be provided in the plant downstream of the fluidized bed, either in the reactor and/or outside this, both in order to comply with emission regulations and for economic reasons because the catalyst used in the Deacon process is expensive. If steam escapes from the tubes of the shell-and-tube heat exchanger into the interior of the fluidized-bed reactor as a result of rupture of a tube, the catalyst particles are moistened and block the retention devices. Blockage of the retention devices results in a sharp increase in the steam pressure in the reactor so that this can burst. Since highly corrosive chlorine and hydrogen chloride would escape in this event, such a malfunction has to be avoided at all costs.

For safety reasons, the plant has to be designed so that in the event of a malfunction due to a ruptured tube, the reactor does not burst. Two options are known for this in the prior art, firstly to build the reactor so that it is intrinsically safe and secondly to provide a bursting disk via which the steam is let off. The first option has the disadvantage that the reactor has to be designed for a very high maximum pressure and becomes correspondingly expensive. The second option has the disadvantage that the exiting chlorine-comprising steam cannot be discharged directly into the surroundings but only via a chlorine scrubber which has to have very large dimensions.

It was therefore an object of the invention to provide a process for preparing chlorine by the Deacon process in a fluidized-bed reactor with removal of the heat of reaction by evaporative cooling by means of water which circulates in the tubes of a shell-and-tube heat exchanger, which process ensures by means of technically simple measures that the fluidized-bed reactor does not burst in the event of a ruptured tube.

The object is achieved by a process for preparing chlorine by oxidation of hydrogen chloride in the presence of a heterogeneous particulate catalyst by the Deacon process in a fluidized-bed reactor, in which the heat of reaction is removed by evaporative cooling by means of water which circulates in the tubes of a shell-and-tube heat exchanger, with the water being fed from a steam drum via a feed line to the tubes of the shell-and-tube heat exchanger at one end of these, being heated in the tubes by uptake of the heat of reaction and partly vaporizing to give a water/steam mixture which at the other end of the tubes of the shell-and-tube heat exchanger is recirculated via a return line to the steam drum, wherein the maximum pressure for which the fluidized-bed reactor has to be designed to allow for the event of rupture of a tube of the shell-and-tube heat exchanger is minimized by a valve which in the event of a pressure increase as a result of rupture of a tube closes the feed line and the return line is installed in the feed line and the return line and thereby prevents water flowing from the steam drum into the fluidized-bed reactor.

It has been found that it is possible in a simple way to carry out the Deacon process in a fluidized-bed reactor in such a way that the maximum pressure for which the reactor has to be designed so that it does not burst in the event of rupture of a tube is minimized by isolating the shell-and-tube heat exchanger by provision of valves in the feed line to and in the return line from the fluidized-bed reactor, so that in the event of rupture of a tube the steam circuit comprising the shell-and-tube heat exchanger, the steam drum, the pump and the connecting lines empties only partly into the fluidized-bed reactor. Only the hold-up in the heat exchanger itself and the quantity of water which flows from the steam circuit within the reaction time of the valves until the latter are closed flow into the reactor. To keep the amount of water which continues to flow in as small as possible, it is advantageous to install the valves in the feed line and the return line as close as possible to the fluidized-bed reactor. The valves should advantageously have a very short reaction time, and preference is given to using quick-closing valves having a very short reaction time. The valves are advantageously installed in a redundant configuration, i.e. in duplicate, in order to ensure operation in the event of failure of a valve.

The malfunction due to rupture of a tube and escape of tube water into the interior of the reactor is detected by the flow of the cooling water in the feed line and/or in the return line to or from the shell-and-tube heat exchanger being measured continuously. The difference between the flow in the feed line and the flow in the return line is preferably measured continuously. As soon as the difference in the flow in the feed line and in the return line is greater than zero, in particular greater than 10 kg/s, a signal is transmitted to the valves in the feed line and in the return line and these are closed.

The shell-and-tube heat exchanger is preferably operated at an operating pressure in the range from 10 to 200 bar gauge, more preferably from 20 to 160 bar gauge, particularly preferably from 30 to 120 bar gauge.

In a preferred embodiment, a cyclone and downstream of the cyclone a filter are installed downstream of the fluidized-bed reactor to retain the heterogeneous particulate catalyst and a bursting disk which bursts when the cyclone is blocked is provided in a bypass line between the fluidized-bed reactor and the filter so that in the event of blockage of the cyclone the contents of the fluidized-bed reactor flow into the filter and utilize the volume of the latter for depressurization.

The water is preferably fed to the tubes of the shell-and-tube heat exchanger via a pump. In one embodiment, the water circulates in the steam circuit by natural convection.

Orifice plates can advantageously be provided in the heat exchanger tubes, in the feed line and/or in the return line so that less water flows out from the steam circuit until closure of the valves. It is particularly advantageous to install orifice plates in the feed line.

In a further embodiment, the return line is configured with very little hold-up, preferably less than 100 l, i.e. is made as short as possible, and does not dip into the liquid phase in the steam drum. As a result, only steam but no water is drawn from the steam drum and thus a significantly smaller volume compared to water.

In a further advantageous embodiment, nonreturn valves are provided in the return line, preferably one to three valves connected in series. These prevent water from flowing from the return line back into the shell-and-tube heat exchanger.

Furthermore, it is proposed that tubes having a very small diameter be used for the shell-and-tube heat exchanger. At a given surface area of the heat exchanger, this reduces the volume of the latter and the amount of water present therein. Furthermore, less water flows out from a ruptured tube having a smaller diameter.

As further additional features, it is proposed that the heat exchanger be segmented, i.e. two or more, preferably from two to twenty, more preferably from three to seven, separate heat transfer medium circuits, each having its own feed line and return line, be provided. As a result, only the contents of one shell-and-tube heat exchanger segment flow into the reactor in the event of a ruptured tube.

The invention is illustrated below with the aid of examples and a drawing.

### EXAMPLES

In a plant having a capacity of 17.8 t/h of chlorine, a reactor having a free volume of 300 m³ is operated at 440° C. and 2 bar gauge. In accordance with the reaction enthalpy (807 kJ/kg of chlorine), about 4 MW of heat of reaction Q* have to be removed from the reactor. The steam system operates at 160 bar gauge and accordingly 360° C. At an average heat transfer coefficient (k value) of the heat exchanger of 400 W/m²K, the relationship Q*=k×A×ΔT means that a surface area A of 100 m² is required for the heat exchanger. This is configured as a shell-and-tube heat exchanger having tubes which are 60 mm in diameter. The volume of the heat exchanger is given by V=d/4×A and is thus 1.5 m³. The two-phase mixture in the heat exchanger has an average density of 0.6 t/m³. 900 kg of water are thus present in the heat exchanger. 3 t of water are present in the steam drum, 1 t of water is present in the feed line and 1 t of water is present in the return line, giving a total of 5.9 t of water in the overall steam circuit.

A filter is installed downstream of the reactor. The free volume up to the candle filters, i.e. the volume of the feed line and the volume of the filter up to the candle filters, is 100 m³.

A malfunction in which a heat exchanger tube breaks off completely is now assumed. From literature correlations, it was calculated that 163 kg/s of water/steam flow out from the ends of the tube during the first seconds. For the safety analysis, it has to be assumed that the outflowing water immediately vaporizes on the hot catalyst and heats up to 400° C. Furthermore, it has to be assumed that the reactor outlet becomes blocked immediately.

### Example 1 According to the Prior Art

The reactor is equipped with a bursting disk via which the steam is conveyed to a scrubber. This would have to be designed for 326 kg/s of steam.

### Example 2 According to the Prior Art

The reactor does not have a bursting disk and therefore has to be designed so as to be intrinsically safe. After a tube breaks off, all of the water in the steam circuit flows into the reactor, which leads, according to the ideal Gas Law, to a steam pressure of 64 bar a. The reactor thus has to be designed for a maximum pressure of 66 bar gauge.

### Example 1 According to the Invention

Quick-closing valves having a closure time of 3 s are installed in the feed line to and the return line from the shell-and-tube heat exchanger. The flows in the feed line and in the return line are measured. The valves close when the difference between the flow in the feed line and that in the return line is greater than 10 kg/s. These isolate the heat exchanger 3 s after a tube breaks off. Accordingly, the amount of water which flows out is the amount present in the heat exchanger (900 kg) and in addition the amount which additionally flows out during the 3 s, i.e. 3×2×163 kg/s=978 kg, namely a total of 1878 kg. This gives a design pressure for the reactor of 22.3 bar gauge.

### Example 2 According to the Invention

A bursting disk is additionally installed in a bypass line between the fluidized-bed reactor and the filter. As a result, an additional free volume of 100 m³ in addition to the 300 m³ free volume of the reactor, i.e. a total of 400 m³, is available for the water flowing out from the shell-and-tube heat exchanger in the event of rupture of a tube.

This gives a design pressure for the reactor of 17.3 bar gauge.

### Example 3 According to the Invention

40 mm orifice plates which, corresponding to the reduction in the cross section by a factor of 4/9, limit the outflow of water to 72 kg/s are installed at the inlet and outlet of each tube. A total of 1332 kg of water then flow into the reactor and the design pressure is 12.8 bar gauge. Due to the additional pressure drop at the orifice plates, it is absolutely necessary to use a pump in the steam circuit.

### Example 4 According to the Invention

The steam drum is positioned very close to the reactor so that the hold-up in the return line to the steam drum is only 72 kg. At the same time, the return line does not dip into the liquid phase in the steam drum and the steam drum is filled to an extent of only ⅔ with water. As a result, the return line empties within one second after breaking-off of a tube and only steam flows out. In the form of steam, the amount of water flowing out through the orifice plate is only about ⅓ of the amount of liquid and thus 24 kg/s in the case of a 40 mm orifice plate. A total of 1236 kg of water then flow out into the fluidized-bed reactor and the design pressure is 12.0 bar gauge.

### Example 5 According to the Invention

Nonreturn valves which limit the inflow of water to 1/10 of the normal value are additionally provided in the return line. Accordingly, only 7 kg/s flow out from the return line. A total of 1137 kg of water flow out and the design pressure is 11.2 bar gauge.

### Example 6 According to the Invention

The tube bundle of the shell-and-tube heat exchanger is additionally made of 30 mm tubes. Orifice plates are not installed. As a result, the surface area A of the heat exchanger is 100 m² and the hold-up is 0.75 m³, corresponding to 450 kg of water. 41 kg/s now flow out from the feed line and 7 kg/s flow from the return line due to the limitation achieved by the nonreturn valves. Accordingly, a total of 594 kg of water flow out and the design pressure is 6.8 bar gauge.

### Example 7 According to the Invention

The heat exchanger is additionally segmented into three equal parts. The hold-up of a segment is then 0.25 m³, corresponding to 150 kg of water. Each of the segments is equipped with quick-closing valves and nonreturn valves, so that the amount of water which flows out is the same as in example 5. Thus, a total of 294 kg of water flow out and the design pressure of the fluidized-bed reactor is 4.4 bar gauge.

The single FIGURE schematically shows a plant for carrying out the process of the invention having a fluidized-bed reactor 1, a steam circuit comprising a shell-and-tube heat exchanger 2 which is located in the fluidized-bed reactor, a steam drum 4, pump 3, and also feed line 5 and return line 6 between steam drum and shell-and-tube heat exchanger. According to the invention, a valve 7 is located in the feed line and in the return line, as close as possible to the reactor 1.

A cyclone 8 is provided in the upper region of the reactor and downstream of this cyclone 8 a filter 9 located outside the reactor. A bursting disk 11 is, according to the invention, provided in a bypass line 10 between the fluidized-bed reactor 1 and the filter 9.

1. A process for preparing chlorine, comprising oxidation of hydrogen chloride in the presence of a heterogeneous particulate catalyst by the Deacon process in a fluidized-bed reactor,
wherein
the heat of reaction is removed by evaporative cooling with water,
the water circulates in tubes of a shell-and-tube heat exchanger,
the water is fed from a steam drum through a feed line to one end of the tubes of the shell-and-tube heat exchanger,
the water is heated in the tubes by uptake of the heat of reaction and is partly vaporizing to give a water/steam mixture,
at the other end of the tubes of the shell-and-tube heat exchanger the water/steam mixture is recirculated through a return line to the steam drum, wherein
the maximum pressure for which the fluidized-bed reactor has to be designed to allow for the event of rupture of a tube of the shell-and-tube heat exchanger is minimized by at least one valve which, in the event of a pressure increase as a result of rupture of a tube, closes the feed line and the return line, and
the at least one valve is installed in the feed line and the return line and thereby prevents water flowing from the steam drum into the fluidized-bed reactor.

2. The process of claim 1, wherein the shell-and-tube heat exchanger is operated at a pressure in the range from 10 to 200 bar gauge.

3. The process of claim 2, wherein the shell-and-tube heat exchanger is operated at a pressure in the range from 20 to 160 bar gauge.

4. The process of claim 3, wherein the shell-and-tube heat exchanger is operated at a pressure in the range from 30 to 120 bar gauge.

5. The process of claim 1, wherein the at least one valve is installed in duplicate.

6. The process of claim 1, wherein the at least one valve is configured as a quick-closing valve.

7. The process of claim 1, wherein
a cyclone and downstream of the cyclone, a filter are installed downstream of the fluidized bed of the fluidized-bed reactor to retain the heterogeneous particulate catalyst,
a bursting disk, which bursts when the cyclone is blocked, is provided in a bypass line between the fluidized-bed reactor and the filter so that, in the event of blockage of the cyclone, the contents of the fluidized-bed reactor flow into the filter and utilize the volume of the filter for depressurization.

8. The process of claim 1, wherein at least one orifice plate is provided in the tubes of the shell-and-tube heat exchanger, in the feed line and/or in the return line.

9. The process of claim 1, wherein the return line is configured with hold-up of less than 100 l.

10. The process of claim 1, wherein at least one nonreturn valve is installed in the return line.

11. The process of claim 1, wherein the tubes of the shell-and-tube heat exchanger have diameters less than or equal to 100 mm.

12. The process of claim 11, wherein the tubes of the shell-and-tube heat exchanger have a diameter in the range from 1 to 100 mm.

13. The process of claim 12, wherein the tubes of the shell-and-tube heat exchanger have a diameter in the range from 25 to 60 mm.

14. The process of claim 1, wherein the shell-and-tube heat exchanger is segmented into from 2 to 20 separate heat transfer medium circuits, each having a dedicated feed line and a dedicated return line.

15. The process of claim 14, wherein the shell-and-tube heat exchanger is segmented into from 3 to 7 separate heat transfer medium circuits.

16. The process of claim 8, wherein the at least on orifice plate is provided in the feed line.

17. The process of claim 8, wherein the at least one orifice plate is provided in the feed line and in the return line.

18. The process of claim 9, wherein the return line does not dip into the liquid phase in the steam drum.

19. The process of claim 1, wherein two or more of the at least one return value, which are connected in series, are installed in the return line.

20. The process of claim 19, wherein one to three of the at least one nonreturn valve, which are connected in series, are installed in the return line.
